(19) United States
(12) Patent Application Publication
(10) Pub. No.: US 2026/0258235 A1
(43) Pub. Date: Sep. 3, 2026

(54) POLYPROPYLENE COMPOSITION FOR PREPARING A FOAM AND A FOAM COMPRISING THE SAME

(71) Applicant: BOREALIS AG, Vienna (AT)

(72) Inventors: Antti Tapio Tynys, Linz (AT); Norbert Reichelt, Linz (AT)

(21) Appl. No.: 18/993,802

(22) PCT Filed: Jul. 25, 2023
(86) PCT No.: PCT/EP2023/070514

§ 371 Date: Jan. 13, 2025

(30) Foreign Application Priority Data
Jul. 27, 2022 (EP) 22187209.6

(51) Int. Cl. C08L 23/12; C08J 3/20; C08J 3/22; C08J 9/00; C08J 9/14; C08K 3/34

(52) U.S. Cl. CPC C08L 23/12; C08J 3/203; C08J 3/226; C08J 9/0061; C08J 9/141; C08K 3/346; C08J 2201/03; C08J 2203/14; C08J 2323/12; C08J 2423/12; C08L 2203/14; C08L 2205/025; C08L 2207/07

(57) ABSTRACT

The present application provides a polypropylene composition for preparing a foam. The polypropylene composition comprises: (a) at least 40.0 wt. % of a long chain branched polypropylene, and (b) at least 20.0 wt. % of a linear polypropylene, wherein the weight amounts are based on the total weight of the polypropylene composition, and wherein the polypropylene composition has a melt flow rate MFR₂ (ISO 1133, 2.16 kg load, 230° C.) of at least 2.5 g/10 min. Furthermore, a foam is provided which comprises said polypropylene composition as well as processes for preparing said polypropylene composition and said foam.

### TECHNICAL FIELD

The present application relates to a polypropylene composition for preparing a foam. The present application further relates to a foam comprising said polypropylene composition as well as to processes for preparing said materials. The present application also relates to the behavior of said polypropylene composition under shear exposure in melt extrusion processes.

### BACKGROUND

Long chain branched polypropylenes are known for their high melt strength which makes those materials particularly useful for various applications such as foaming applications.

It is known that long chain branched polypropylenes, and other polypropylenes having a high melt strength, can degrade when subjected to specific processing conditions such as melt processing in an extruder. A significant decrease in melt strength and/or in melt extensibility is typically observed after processing of long chain branched polypropylene. This is related to the shear exposure of the long chain branched polypropylene during the extrusion process. The decreased melt strength has a negative effect on the foamability of the long chain branched polypropylene, or a high melt strength polypropylene composition comprising the same, after extrusion foaming. If the melt strength of the processed polypropylene composition drops below a certain value due to degradation under shear, the composition may no longer be suitable to serve its original purpose, like being foamable.

The loss of melt strength ultimately limits the re-usability of used or recycled long chain branched polypropylene or polypropylene compositions comprising the same in foaming processes. For example, the addition of more than about 10 wt. % of high melt strength polypropylene recyclates to produce low density extrusion foam without loss of foaming efficiency (increase of density) is a common problem.

Some options are known to reduce the loss of melt strength during processing of high melt strength polymer compositions. For example, it is possible to reduce the shear exposure of the polymer during extrusion by decreasing output of the extruder and/or increasing the size of the extruder while keeping the same output level. However, both approaches are expensive and often not economically feasible.

An alternative approach is to modify the polymer composition used for the extrusion foam process, i.e. to modify the polymer composition to be less shear sensitive enabling better foaming and better quality of recycled material.

WO2017/068106 A1 relates to long chain branched polypropylene compositions comprising a long chain branched propylene homopolymer or copolymer and a linear propylene homopolymer or copolymer. The long-chain branched polypropylene composition is suitable for foam application. The linear propylene homopolymer or copolymer has a specifically low melt flow rate. Blending a low melt flow rate linear polypropylene with a high long chain branched polypropylene typically further decreases the low melt flow rate of the long chain branched polypropylene which can have a negative impact on processability.

There is a continuing need in the art for polypropylene compositions which are suitable for foaming and are less shear sensitive than comparable materials. It is further desirable that the polypropylene composition has a comparatively high melt flow rate to provide good processability, e.g. in the production of low density foam.

Objects of the present invention are to provide a polypropylene composition for preparing a foam, a foam comprising the same, and a process for preparing said materials.

### SUMMARY OF INVENTION

One aspect of the present invention provides a polypropylene composition for preparing a foam. The polypropylene composition comprises:
(a) at least 40.0 wt. % of a long chain branched polypropylene, and
(b) at least 20.0 wt. % of a linear polypropylene.

The weight amounts of the long chain branched polypropylene (a) and the linear polypropylene (b) are based on the total weight of the polypropylene composition. It further required that the polypropylene composition has a melt flow rate MFR₂ (ISO 1133, 2.16 kg load, 230° C.) of at least 2.5 g/10 min.

One finding of the inventors is that the polypropylene composition provided herein is less shear sensitive and has better processability than comparable polypropylene compositions for preparing foams, and specifically low density foams. The reduced shear sensitivity can be shown by an increased melt strength stability of the polypropylene composition during extrusion processing. The reduced shear sensitivity and/or reduced degradation during processing can improve recyclability of the polypropylene composition, since the material is less prone to lose its functionality due to continued degradation during its reuse. It has further been found that the polypropylene composition is suitable for preparing a foam, and particularly a low density foam. The polypropylene composition can be foamed to low density using standard commercial foaming processes.

According to one preferred embodiment of the present invention, a polypropylene composition is provided for preparing a foam, wherein the polypropylene composition comprises:
(a) at least 40.0 wt. % of a long chain branched polypropylene, and
(b) at least 30.0 wt. % of a linear polypropylene,
wherein the weight amounts are based on the total weight of the polypropylene composition, and
wherein the polypropylene composition has a melt flow rate MFR₂ (ISO 1133, 2.16 kg load, 230° C.) in a range of 2.5 to 30.0 g/10 min.

Another aspect of the present invention provides a foam. The foam comprises the polypropylene composition according to one embodiment of the invention.

Another aspect of the present invention provides a process for preparing the polypropylene composition according to one embodiment of the invention, or the foam according to one embodiment of the invention. The process comprises the steps of:
a) providing a mixture comprising:
   a long chain branched polypropylene starting material,
   a linear polypropylene starting material, and
   optionally one or more additives;
b) melt blending the mixture provided in step a) to obtain a polypropylene composition; and
c) optionally foaming the melt-blended mixture provided in step b) to obtain a foam.

In another aspect, the present invention provides the use of the polypropylene composition according to one embodiment of the invention for preparing a foam.

Further embodiments of the invention are defined in the dependent claims.

According to one embodiment of the invention, the polypropylene composition comprises:
(a) 40.0 to 80.0 wt. %, preferably 50.0 to 70.0 wt. %, more preferably 55.0 to 65.0 wt. %, and even more preferably 57.5 to 62.5 wt. %, of the long chain branched polypropylene,
(b) 20.0 to 60.0 wt. %, preferably 30.0 to 50.0 wt. %, more preferably 35.0 to 45.0 wt. %, and even more preferably 37.5 to 42.5 wt. %, of the linear polypropylene, and
(c) optionally 0.01 to 5.0 wt. %, preferably 0.1 to 4.0 wt. %, more preferably 0.2 to 3.0 wt. %, and even more preferably 0.2 to 2.0 wt. %, of one or more additives,
wherein all weight amounts are based on the total weight of the polypropylene composition, and optionally wherein the components (a) to (c) add up to 100 wt. %.

According to one embodiment of the invention, the polypropylene composition has one or more of, preferably two or more of, and more preferably all of, the following properties:
i) a melt strength F₃₀ (ISO 16790:2005) of at least 5.0 cN, preferably in the range of 5.0 to 30.0 cN, more preferably in the range of 5.0 to 27.5 cN, and even more preferably in the range of 5.0 to 23.0 cN;
ii) a melt flow rate MFR₂ (ISO 1133, 2.16 kg load, 230° C.) in the range of 2.5 to 30.0 g/10 min, and preferably in the range of 3.0 to 20.0 g/10 min; and
iii) a melt extensibility v₃₀ (ISO 16790:2005) in the range of 180 to 320 mm/s, preferably 200 to 280 mm/s, and more preferably 220 to 260 mm/s.

According to one embodiment of the invention, the polypropylene composition has a shear thinning index SHI_{(0.05/300)}, determined as described in the specification, of less than 40.0, and preferably in the range of 10.0 to less than 40.0.

According to one embodiment of the invention, the long chain branched polypropylene is a long chain branched propylene homopolymer.

According to one embodiment of the invention, the long chain branched polypropylene is derived from a long chain branched polypropylene starting material which is obtained by treating a linear polypropylene with a radical forming agent, preferably in the presence of bifunctionally unsaturated monomer(s) and/or multifunctionally unsaturated low molecular weight polymer(s).

According to one embodiment of the invention, the linear polypropylene is a linear propylene homopolymer.

According to one embodiment of the invention, the polypropylene composition comprises one or more additives, wherein the one or more additives comprise a nucleating agent, preferably a talc as nucleating agent.

According to one embodiment of the invention, the long chain branched polypropylene is derived from a long chain branched polypropylene starting material having one or more of, preferably two or more of, and more preferably all of, the following properties:
i) a melt strength F₃₀ (ISO 16790:2005) of 20.0 to 50.0 cN, preferably in the range of 25.0 to 45.0 cN, and more preferably in the range of 30.0 to 40.0 cN,
ii) a melt extensibility v₃₀ (ISO 16790:2005) in the range of 190 to 320 mm/s, preferably 210 to 300 mm/s, and more preferably 230 to 280 mm/s,
iii) a melt flow rate MFR₂ (ISO 1133, 2.16 kg load, 230° C.) in the range of 0.5 to 5.0 g/10 min, preferably 1.0 to 3.0 g/10 min, and more preferably 1.2 to 2.5 g/10 min.

According to one embodiment of the invention, the linear polypropylene is derived from a linear polypropylene starting material having one or more of, preferably two or more of, and more preferably all of, the following properties:
i) a melt strength F₃₀ (ISO 16790:2005) of at most 15.0 cN, preferably at most 10.0 cN, and more preferably at most 8.0 cN;
ii) a melt extensibility v₃₀ (ISO 16790:2005) of at most 210 mm/s, preferably at most 200 mm/s, and more preferably of at most 190 mm/s,
iii) a melt flow rate MFR₂ (ISO 1133, 2.16 kg load, 230° C.) in the range of 2.0 to 50.0 g/10 min, preferably 2.5 to 40.0 g/10 min, and more preferably 2.8 to 30.0 g/10 min.

According to one embodiment of the invention, the polypropylene composition is obtainable or obtained using a mixture, and preferably a dry blend, comprising a long chain branched polypropylene starting material and a linear polypropylene starting material, the linear polypropylene starting material having the following properties:
i) a melt flow rate MFR₂ (ISO 1133, 2.16 kg load, 230° C.) which is higher than the melt flow rate MFR₂ (ISO 1133, 2.16 kg load, 230° C.) of the long chain branched polypropylene starting material, and
ii) a melt strength F₃₀ (ISO 16790:2005) which is lower than the melt strength F₃₀ (ISO 16790:2005) of the long chain branched polypropylene starting material.

According to one embodiment of the invention, the foam has a density of 100 kg/m³ or less, preferably in the range of 20 to 100 kg/m³.

According to one embodiment of the invention, the foam has one or both of the following properties:
i) a melt strength F₃₀ (ISO 16790:2005) of at most 23.0 cN, and preferably in the range of 5.0 to 23.0 cN,
ii) a shear thinning index SHI_{(0.05/300)}, determined as described in the specification, of less than 40.0, and preferably in the range of 10.0 to less than 40.0.

Where the term “comprising” is used in the present description and claims, it does not exclude other non-specified elements of major or minor functional importance. For the purposes of the present invention, the term “essentially consisting of” and “consisting of” are considered to be specific embodiments of the term “comprising of”. If hereinafter a group is defined to comprise at least a certain number of features or embodiments, this is also to be understood to disclose a group, which optionally essentially consists only of these features or embodiments or consists only of these features or embodiments. Whenever the terms “including” or “having” are used, these terms are meant to be equivalent to “comprising” as defined above.

In the following, the present invention is described in more detail.

### DETAILED DESCRIPTION

### Polypropylene Composition for Preparing a Foam

One aspect of the present invention provides a polypropylene composition for preparing a foam. The polypropylene composition comprises:
(a) at least 40.0 wt. % of a long chain branched polypropylene, and
(b) at least 20.0 wt. % of a linear polypropylene.

The weight amounts of the long chain branched polypropylene (a) and the linear polypropylene (b) are based on the total weight of the polypropylene composition. It further required that the polypropylene composition has a melt flow rate MFR₂ (ISO 1133, 2.16 kg load, 230° C.) of at least 2.5 g/10 min.

According to one preferred embodiment of the present invention, a polypropylene composition is provided for preparing a foam, wherein the polypropylene composition comprises:
(a) at least 40.0 wt. % of a long chain branched polypropylene, and
(b) at least 30.0 wt. % of a linear polypropylene,
wherein the weight amounts are based on the total weight of the polypropylene composition, and
wherein the polypropylene composition has a melt flow rate MFR₂ (ISO 1133, 2.16 kg load, 230° C.) in a range of 2.5 to 30.0 g/10 min.

The polypropylene composition provided herein is suitable for preparing a foam. “Suitable for preparing a foam” includes those polypropylene compositions which can be foamed by using a physical foaming agent which is externally provided, e.g. in an extrusion foaming process. Thus, “suitable for preparing a foam” is not to be understood in that the polypropylene composition necessarily contains a foaming agent (although this is possible).

According to one preferred embodiment, the polypropylene composition is suitable for preparing a foam by means of an extrusion foaming process using a physical foaming agent (e.g. a gas like butane).

However, this is not to be understood in that the polypropylene composition is only suitable for preparing a foam. Other applications and uses of the polypropylene composition provided herein are also possible and are not excluded.

### Long Chain Branched Polypropylene (a)

The polypropylene composition comprises a long chain branched polypropylene as a component (a). The long chain branched polypropylene being present in the polypropylene composition according to the invention is also referred to herein as “long chain branched polypropylene (a)”.

Long chain branched polypropylenes are known in the art. Long chain branched polypropylene differs from a linear polypropylene in that the polypropylene backbone contains long side chains whereas a non-branched polypropylene, i.e. a linear polypropylene, does not contain long side chains. The long side chains branching out from the polymer backbone have significant impact on the rheology of the polypropylene. Accordingly, linear polypropylenes and long chain branched polypropylenes can be clearly distinguished by e.g. their flow behavior under stress (e.g. a ratio of polymer melt viscosities measured under differing loads). Additionally or alternatively, long chain branching can be determined by analysing the content of long chain branches by NMR and/or by measuring the long chain branching index g′ by using e.g. SEC/VISC-LS (size exclusion chromatography/viscometry-light scattering) as known in the art. Branching index g′ is a parameter of the degree of branching. The branching index g′ correlates with the amount of branches of a polymer. A low g′-value is an indicator for a highly branched polymer. In other words, if the g′-value decreases, the branching of the polypropylene increases. For instance, the value of g′ of at least 0.96, such as at least 0.97 or at least 0.98 typically indicates that long chain branches are not present. On the other hand, a value of g′ of 0.9 or less (e.g. 0.6 to 0.9), such as 0.8 or less, typically indicates that the polymer contains long chain branches. Further details regarding branching index g′ and methods for its determination are described, for example, in the section “Measuring methods” of EP3280748B1, which is incorporated herein by reference.

Due to the specific melt strength properties, long chain branched polypropylenes are also referred to in the art as high melt strength polypropylenes.

Long chain branching can be generally achieved by using specific catalysts, i.e. specific single-site and/or metallocene catalysts, or by chemical modification. Concerning the preparation of a long chain branched polypropylene obtained by the use of a specific catalyst reference is made to EP 1 892 264. With regard to a long chain branched polypropylene obtained by chemical modification it is referred to, for instance, EP 0 787 750, EP 0879830 A1 and EP 0890612 A2.

Long chain branched polypropylenes typically have a comparatively low melt flow rate combined with high melt strength and a high melt extensibility.

The polypropylene composition comprises at least one long chain branched polypropylene (a), like from one to three long chain branched polypropylene (a). For example, the polypropylene composition can comprise one long chain branched polypropylene (a).

The long chain branched polypropylene (a) is principally not limited as long as it is suitable for preparing the polypropylene composition according to one embodiment of the invention.

The long chain branched polypropylene is not specifically limited in terms of the linear polypropylene which forms its longest chain or backbone. The long chain branched polypropylene (a) can be a long chain branched propylene copolymer or a long chain branched propylene homopolymer.

The long chain branched polypropylene (a) may be a long chain branched propylene copolymer, like a long chain branched propylene random copolymer. In case the long chain branched polypropylene (a) is a propylene copolymer, it may comprise comonomers selected from the group consisting of ethylene and/or C₄ to C₁₀ α-olefins, e.g. 1-butene and/or 1-hexene, with ethylene and/or 1-butene being preferred. For example, the long chain branched propylene copolymer may be a long chain branched C2C3 copolymer.

The comonomer content of the long chain branched propylene copolymer may be in the range of more than 0.5 to 10.0 mol.-%, still more preferably in the range of more than 0.5 to 7.0 mol.-%.

It is preferred that the long chain branched polypropylene (a) is a long chain branched propylene homopolymer. Hence, according to one preferred embodiment of the invention, the long chain branched polypropylene (a) is a long chain branched propylene homopolymer.

In case the long chain branched polypropylene is a long chain branched polypropylene which is obtained by chemical modification of a linear polypropylene, the definition of propylene homopolymer and propylene copolymer is to be understood to refer to the linear polypropylene which is used to obtain the long chain branched polypropylene by chemical modification, e.g. with bifunctionally unsaturated monomer(s) and/or multifunctionally unsaturated low molecular weight polymer(s) in reactive extrusion.

The polypropylene composition comprises at least 40.0 wt. % of the long chain branched polypropylene (a), based on the total weight of the polypropylene composition. Preferably, the polypropylene composition comprises at least 50.0 wt. %, more preferably at least 55.0 wt. %, and even more preferably at least 57.5 wt. %, of the long chain branched polypropylene, based on the total weight of the polypropylene composition.

It is more preferred that the polypropylene composition comprises 50.0 to 70.0 wt. %, even more preferably 55.0 to 65.0 wt. %, and yet even more preferably 57.5 to 62.5 wt. %, of the long chain branched polypropylene (a), based on the total weight of the polypropylene composition.

The long chain branched polypropylene (a) being present in the inventive polypropylene composition is preferably derived from a specific long chain branched polypropylene starting material, i.e. a material which is used to prepare the inventive polypropylene composition.

The long chain branched polypropylene starting material preferably has specific properties, like specific melt properties.

The long chain branched polypropylene starting material preferably has a melt strength F₃₀ (ISO 16790:2005) of 20.0 to 50.0 cN, preferably in the range of 25.0 to 45.0 cN, and more preferably in the range of 30.0 to 40.0 cN, like in the range of 32.0 to 38.0 cN.

The long chain branched polypropylene starting material preferably has a melt extensibility v₃₀ (ISO 16790:2005) in the range of 190 to 320 mm/s, preferably 210 to 300 mm/s, and more preferably 230 to 280 mm/s, like in the range of 240 to 280 mm/s.

The long chain branched polypropylene starting material preferably has a melt flow rate MFR₂ (ISO 1133, 2.16 kg load, 230° C.) in the range of 0.5 to 5.0 g/10 min, preferably 1.0 to 3.0 g/10 min, and more preferably 1.2 to 2.5 g/10 min, like in the range of 1.4 to 2.3 g/10 min.

According to one preferred embodiment, the long chain branched polypropylene starting material has two or more, and more preferably all, of the following properties:
i) a melt strength F₃₀ (ISO 16790:2005) of 20.0 to 50.0 cN, preferably in the range of 25.0 to 45.0 cN, and more preferably in the range of 30.0 to 40.0 cN, like in the range of 32.0 to 38.0 cN,
ii) a melt extensibility v₃₀ (ISO 16790:2005) in the range of 190 to 320 mm/s, preferably 210 to 300 mm/s, and more preferably 230 to 280 mm/s, like in the range of 240 to 280 mm/s,
iii) a melt flow rate MFR₂ (ISO 1133, 2.16 kg load, 230° C.) in the range of 0.5 to 5.0 g/10 min, preferably 1.0 to 3.0 g/10 min, and more preferably 1.2 to 2.5 g/10 min, like in the range of 1.4 to 2.3 g/10 min.

The long chain branched polypropylene starting material can have a melting point of at least 130° C., more preferably of at least 135° C. and most preferably of at least 140° C. The crystallization temperature may be at least 110° C., more preferably at least 120° C.

The long chain branched polypropylene starting material can be obtained by treating linear polypropylene with a radical forming agent, preferably in the presence of bifunctionally unsaturated monomer(s) and/or multifunctionally unsaturated low molecular weight polymer(s).

The radical forming agent may be a peroxide, and preferably is an organic peroxide, like a thermally decomposable organic peroxide. The multifunctionally unsaturated low molecular weight polymer(s) preferably have a number average molecular weight (Mn)<10000 g/mol. Suitable low molecular weight polymers are polybutadienes, and preferably polybutadienes with a microstructure being partially or predominantly in the 1,2-(vinyl) configuration. The bifunctionally unsaturated monomers may be selected from divinyl compounds, allyl compounds, dienes, and the like. Preferably, the bifunctionally unsaturated monomer is selected from the group consisting of 1,3-butadiene, isoprene, dimethyl butadiene, divinylbenzene, and mixtures thereof. A suitable method to obtain the non-used long chain branched PP, is for instance disclosed in EP 0 787 750 A2, EP 0 879 830 A1 and EP 0 890 612 A2.

A suitable long chain branched polypropylene starting material is WB140HMS™ commercially available from Borealis AG.

### Linear Polypropylene (b)

The polypropylene composition comprises a linear polypropylene as a component (b). The linear polypropylene being present in the polypropylene composition according to the invention is also referred to herein as “linear polypropylene (b)”.

Linear polypropylenes are also known in the art. A linear polypropylene differs from a long chain branched polypropylene in that the polypropylene chain essentially does not contain side chains, i.e. is not branched. A skilled person can distinguish between a linear polypropylene and a long chain branched polypropylene. For example, and as set out above, linear polypropylenes and long chain branched polypropylenes can be clearly distinguished by their flow behavior under stress. The presence of branching in a polypropylene may also be determined, e.g. by determining the branching index, using gel phase chromatography (GPC). As is known in the art, linear polypropylene can be produced, for example, by using a suitable single-site catalyst or a Ziegler Natta catalyst.

The polypropylene composition comprises at least one linear polypropylene (b), like from one to three linear polypropylenes (b).

The linear polypropylene (b) is principally not limited as long as it is suitable for preparing the polypropylene composition according to the invention. The linear polypropylene (b) is not specifically limited in terms of its chemical composition. The linear polypropylene (b) can be a propylene copolymer or a propylene homopolymer.

The linear polypropylene (b) may be a propylene copolymer, like a propylene random copolymer. In case the linear polypropylene (b) is a propylene copolymer, it may comprise comonomers selected from the group consisting of ethylene and/or C₄ to C₁₀ α-olefins, e.g. 1-butene and/or 1-hexene, with ethylene and/or 1-butene being preferred. For example, the linear polypropylene (b) may be C2C3 copolymer.

The comonomer content of the linear polypropylene (b) may be in the range of more than 0.5 to 10.0 mol %, still more preferably in the range of more than 0.5 to 7.0 mol %.

It is preferred that the linear polypropylene (b) is a linear propylene homopolymer. Hence, according to one preferred embodiment of the invention, the linear polypropylene (b) is a linear propylene homopolymer.

According to one more preferred embodiment, the long chain branched polypropylene (a) and the linear polypropylene (b) are propylene homopolymers.

The polypropylene composition comprises at least 20.0 wt. % of the linear polypropylene (b), based on the total weight of the polypropylene composition. Preferably, the polypropylene composition comprises at least 30.0 wt. %, more preferably at least 35.0 wt. %, and even more preferably at least 37.5 wt. %, of the linear polypropylene (b), based on the total weight of the polypropylene composition.

It is more preferred that the polypropylene composition comprises 20.0 to 60.0 wt. %, more preferably 30.0 to 50.0 wt. %, even more preferably 35.0 to 45.0 wt. %, and yet even more preferably 37.5 to 42.5 wt. %, of a linear polypropylene (b), based on the total weight of the polypropylene composition.

The linear polypropylene (b) being present in the inventive polypropylene composition is preferably derived from a specific linear polypropylene starting material, i.e. a material which is used to prepare the inventive polypropylene composition.

The linear polypropylene starting material preferably has a melt strength F₃₀ (ISO 16790:2005) of at most 15.0 cN (e.g. in the range of 0.1 to 15.0 cN), preferably at most 10.0 cN (e.g. in the range of 0.1 to 10.0 cN), and more preferably at most 8.0 cN, like in the range of 0.1 to 8.0 cN or in the range of 0.5 to 8.0 cN.

The linear polypropylene starting material preferably has a melt extensibility v₃₀ (ISO 16790:2005) of at most 210 mm/s (e.g. in the range of 130 mm/s to 210 mm/s), preferably at most 200 mm/s (e.g. in the range of 130 mm/s to 200 mm/s), more preferably of at most 190 mm/s, and most preferably in the range of 140 to 190 mm/s.

The linear polypropylene starting material preferably has a melt flow rate MFR₂ (ISO 1133, 2.16 kg load, 230° C.) in the range of 2.0 to 50.0 g/10 min, preferably 2.5 to 40.0 g/10 min, and more preferably 2.8 to 30.0 g/10 min.

According to one preferred embodiment, the linear polypropylene starting material has two or more, and more preferably all, of the following properties:
i) a melt strength F₃₀ (ISO 16790:2005) of at most 15.0 cN (e.g. in the range of 0.1 to 15.0 cN), preferably at most 10.0 cN (e.g. in the range of 0.1 to 10.0 cN), and more preferably at most 8.0 cN, like in the range of 0.1 to 8.0 cN or in the range of 1.0 to 8.0 cN;
ii) a melt extensibility v₃₀ (ISO 16790:2005) of at most 210 mm/s (e.g. in the range of 100 mm/s to 210 mm/s), preferably at most 200 mm/s (e.g. in the range of 100 mm/s to 200 mm/s), and more preferably of at most 190 mm/s, like in the range of 100 mm/s to 190 mm/s or in the range of 140 to 190 mm/s;
iii) a melt flow rate MFR₂ (ISO 1133, 2.16 kg load, 230° C.) in the range of 2.0 to 50.0 g/10 min, preferably 2.5 to 40.0 g/10 min, and more preferably 2.8 to 30.0 g/10 min.

According to one more preferred embodiment, the linear polypropylene starting material has one or more of, even more preferably two of, and yet even more preferably all of, the following properties:
i) a melt strength F₃₀ (ISO 16790:2005) of at most 5.0 cN (e.g. in the range of 0.1 to 5.0 cN), preferably at most 3.0 cN (e.g. in the range of 0.1 to 3.0 cN), and more preferably at most 2.5 cN, like in the range of 0.1 to 2.5 cN or in the range of 0.5 to 2.5 cN;
ii) a melt extensibility v₃₀ (ISO 16790:2005) of at most 210 mm/s (e.g. in the range of 130 mm/s to 210 mm/s), preferably at most 200 mm/s (e.g. in the range of 130 mm/s to 200 mm/s), more preferably of at most 190 mm/s, and most preferably in the range of 140 to 190 mm/s;
iii) a melt flow rate MFR₂ (ISO 1133, 2.16 kg load, 230° C.) in the range of 2.0 to 35.0 g/10 min, preferably 5.0 to 20.0 g/10 min, and more preferably 7.5 to 18.0 g/10 min, like in the range of 10.0 to 15.0 g/10 min.

One example for a suitable linear polypropylene starting material is the commercial polypropylene HE125MO, HC600TF, and HG313MO from Borealis AG.

### Additives (c)

The polypropylene composition optionally comprises one or more additives as a component (c). The polypropylene composition can comprise one additive or two or more additives, like two to six additives, two to four additives. For example, the polypropylene composition can comprise one or two additives.

The additives may vary depending on the use of the polypropylene composition, the equipment for processing the polypropylene composition, and/or the application of a product, preferably a foam, which comprises the polypropylene composition. Additives can be selected by the person with skill in the art.

It is possible that the polypropylene composition comprises one or more additional polymeric components as additives (c) or as part of the additives (c). The one or more additional polymeric components may be polymeric components which are melt-blendable with the long chain branched polypropylene (a) and the linear polypropylene (b).

For example, additional polymeric component may be polymeric material which is originally brought into the polypropylene composition as part of an additive masterbatch, i.e. as polymeric carrier material. It is however also possible to select the polymeric carrier material of an additive masterbatch to be very similar or essentially identical, for example, the linear polypropylene (b).

For example, the polypropylene composition may be prepared using an additive masterbatch which comprises a nucleating agent and a polymeric carrier resin, like a polypropylene carrier resin. The polymeric carrier resin may be the same as, or different to, the remaining polymeric components (a) or (b).

It is preferred that the polypropylene composition comprises a nucleating agent such as a talc. According to one preferred embodiment, the polypropylene composition comprises one or more additives as a component (c), wherein the one or more additives comprise a nucleating agent. Preferably, the nucleating agent is a talc.

The polypropylene composition can comprise 0.01 to 10.0 wt. % of the one or more additives (c), based on the total weight of the polypropylene composition.

It is preferred that the polypropylene composition comprises 0.01 to 5.0 wt. %, more preferably 0.1 to 4.0 wt. %, even more preferably 0.2 to 3.0 wt. %, like 0.2 to 2.0 wt. %, of one or more additives (c), based on the total weight of the polypropylene composition.

According to one preferred embodiment, the polypropylene composition comprises 0.01 to 5.0 wt. %, more preferably 0.1 to 4.0 wt. %, even more preferably 0.2 to 3.0 wt. %, like 0.2 to 2.0 wt. %, of one or more additives (c), based on the total weight of the polypropylene composition, with the requirement that the one or more additives (c) comprise a nucleating agent, i.e. with the requirement that a nucleating agent is part of the one or more additives (c) or is the one additive (c). The nucleating agent is preferably a talc.

The one or more additives (c) can comprise the nucleating agent, preferably the talc, in an amount of at least 50.0 wt. %, preferably at least 60.0 wt. % to 100 wt. %, based on the total weight of the one or more additives (c). Remaining parts of the one or more additives (c) can be, but are not limited to, a polymeric carrier resin, e.g. a polypropylene which is suitable for use in a polymer masterbatch.

According to one preferred embodiment, the polypropylene composition comprises 0.01 to 5.0 wt. %, more preferably 0.1 to 4.0 wt. %, even more preferably 0.2 to 3.0 wt. %, like 0.2 to 2.0 wt. %, of a nucleating agent, and preferably a talc, based on the total weight of the polypropylene composition.

### The Polypropylene Composition

It is one requirement that the inventive polypropylene composition has a melt flow rate MFR₂ (ISO 1133, 2.16 kg load, 230° C.) of at least 2.5 g/10 min.

Preferably, the polypropylene composition has a melt flow rate MFR₂ (ISO 1133, 2.16 kg load, 230° C.) in the range of 2.5 to 30.0 g/10 min, and more preferably in the range of 3.0 to 20.0 g/10 min, like in the range of 3.0 to 16.0 g/10 min.

The polypropylene composition can have further properties which makes it specifically useful for foaming applications.

The polypropylene composition preferably has a melt strength F₃₀ (ISO 16790:2005) of at least 5.0 cN, more preferably in the range of 5.0 to 30.0 cN, even more preferably in the range of 5.0 to 27.5 cN, and yet even more preferably in the range of 5.0 to 23.0 cN, like in the range of 5.0 to at most 20.0 cN.

The polypropylene composition can have a melt extensibility v₃₀ (ISO 16790:2005) in the range of 180 to 320 mm/s, preferably 200 to 280 mm/s, and more preferably 220 to 260 mm/s.

According to one preferred embodiment of the invention, the polypropylene composition has two or more, and preferably all, of the following properties:
i) a melt strength F₃₀ (ISO 16790:2005) of at least 5.0 cN, preferably in the range of 5.0 to 30.0 cN, more preferably in the range of 5.0 to 27.5 cN, and even more preferably in the range of 5.0 to 23.0 cN, like in the range of 5.0 to at most 20.0 cN;
ii) a melt flow rate MFR₂ (ISO 1133, 2.16 kg load, 230° C.) in the range of 2.5 to 30.0 g/10 min, and preferably in the range of 3.0 to 20.0 g/10 min, like in the range of 3.0 to 16.0 g/10 min; and
iii) a melt extensibility v₃₀ (ISO 16790:2005) in the range of 180 to 320 mm/s, preferably 200 to 280 mm/s, and more preferably 220 to 260 mm/s.

The polypropylene composition is preferably characterized by a comparatively low shear thinning index. As known in the art, shear thinning is the non-Newtonian behavior of fluids whose viscosity decreases under shear strain. The inventive polypropylene composition can show less shear thinning than comparable, foamable polypropylene compositions.

Preferably, the polypropylene composition has a shear thinning index SHI_{(0.05/300)}, determined as described herein under “Methods”, of less than 40.0, and preferably in the range of 10.0 to less than 40.0.

The polypropylene composition preferably has a polydispersity index (PI), determined as described herein under “Methods”, of at most 8.0 Pa⁻¹, and preferably in the range of 2.5 to 8.0 Pa⁻¹, and more preferably in the range of 3.0 to 7.0 Pa⁻¹.

According to one even more preferred embodiment, the polypropylene composition has all of the following properties:
i) a melt strength F₃₀ (ISO 16790:2005) of at least 5.0 cN, preferably in the range of 5.0 to 30.0 cN, more preferably in the range of 5.0 to 27.5 cN, and even more preferably in the range of 5.0 to 23.0 cN, like in the range of 5.0 to at most 20.0 cN;
ii) a melt flow rate MFR₂ (ISO 1133, 2.16 kg load, 230° C.) in the range of 2.5 to 30.0 g/10 min, and preferably in the range of 3.0 to 20.0 g/10 min, like in the range of 3.0 to 16.0 g/10 min;
iii) a melt extensibility v₃₀ (ISO 16790:2005) in the range of 180 to 320 mm/s, preferably 200 to 280 mm/s, and more preferably 220 to 260 mm/s; and
iv) a shear thinning index SHI_{(0.05/300)}, determined as described herein under “Methods”, of less than 40.0, and preferably in the range of 10.0 to less than 40.0.

According to another more preferred embodiment, the polypropylene composition has all of the following properties:
i) a melt strength F₃₀ (ISO 16790:2005) of at least 5.0 cN, preferably in the range of 5.0 to 30.0 cN, more preferably in the range of 5.0 to 27.5 cN, and even more preferably in the range of 5.0 to 23.0 cN, like in the range of 5.0 to at most 20.0 cN;
ii) a melt flow rate MFR₂ (ISO 1133, 2.16 kg load, 230° C.) in the range of 2.5 to 30.0 g/10 min, and preferably in the range of 3.0 to 20.0 g/10 min, like in the range of 3.0 to 16.0 g/10 min;
iii) a melt extensibility v₃₀ (ISO 16790:2005) in the range of 180 to 320 mm/s, preferably 200 to 280 mm/s, and more preferably 220 to 260 mm/s; and
iv) a polydispersity index (PI), determined as described herein under “Methods”, of at most 8.0 Pa⁻¹, and preferably in the range of 2.5 to 8.0 Pa⁻¹, and more preferably in the range of 3.0 to 7.0 Pa⁻¹.

In one more specific embodiment, the polypropylene composition has all of the following properties:
i) a melt strength F₃₀ (ISO 16790:2005) of at least 5.0 cN, like in the range 5.0 to 10.0 cN;
ii) a melt flow rate MFR₂ (ISO 1133, 2.16 kg load, 230° C.) in the range of 5.0 to 20.0 g/10 min, like in the range of 5.0 to 15.0 g/10 min;
iii) a melt extensibility v₃₀ (ISO 16790:2005) in the range of 200 to 280 mm/s, like in the range of 220 to 260 mm/s; and
iv) a shear thinning index SHI_{(0.05/300)}, determined as described herein under “Methods”, of at most 30.0, like in the range of 15.0 to 30.0.

According to one more specific embodiment, the polypropylene composition has all of the following properties:
i) a melt strength F₃₀ (ISO 16790:2005) in the range 5.0 to 10.0 cN;
ii) a melt flow rate MFR₂ (ISO 1133, 2.16 kg load, 230° C.) in the range of 5.0 to 12.0 g/10 min;
iii) a melt extensibility v₃₀ (ISO 16790:2005) in the range of 220 to 260 mm/s; and
iv) a shear thinning index SHI_{(0.05/300)}, determined as described herein under “Methods”, in the range of 20.0 to 30.0.

The polypropylene composition typically comprises the components (a) and (b), and optional component (c) in specific weight amounts.

Preferably, the polypropylene composition comprises:
(a) 40.0 to 80.0 wt. %, preferably 50.0 to 70.0 wt. %, more preferably 55.0 to 65.0 wt. %, and even more preferably 57.5 to 62.5 wt. %, of the long chain branched polypropylene,
(b) 20.0 to 60.0 wt. %, preferably 30.0 to 50.0 wt. %, more preferably 35.0 to 45.0 wt. %, and even more preferably 37.5 to 42.5 wt. %, of a linear polypropylene, wherein the weight amounts are based on the total weight of the polypropylene composition.

The polypropylene composition can further comprise other components in addition to components (a) and (b), like other polymeric blending partners.

It is preferred that the polypropylene composition comprises polymeric material, which is different to the at least one long chain branched polypropylene (a) and the at least one linear polypropylene (b), in an amount of at most 10.0 wt. % (e.g. 0.0 to 10.0 wt. %), and optionally at most 5.0 wt. % (e.g. 0.0 to 5.0 wt. %), and optionally at most 3.0 wt. % (e.g. 0.0 to 3.0 wt. %), based on the total weight of the polypropylene composition.

It is also possible that the polypropylene composition is essentially free of polymeric material which is different to the at least one long chain branched polypropylene (a) and the at least one linear polypropylene (b).

The polypropylene composition preferably comprises one or more additives (c) as described herein above. According to one preferred embodiment, the polypropylene composition comprises:
(a) 40.0 to 80.0 wt. %, preferably 50.0 to 70.0 wt. %, more preferably 55.0 to 65.0 wt. %, and even more preferably 57.5 to 62.5 wt. %, of the long chain branched polypropylene,
(b) 20.0 to 60.0 wt. %, preferably 30.0 to 50.0 wt. %, more preferably 35.0 to 45.0 wt. %, and even more preferably 37.5 to 42.5 wt. %, of the linear polypropylene, and
(c) 0.01 to 5.0 wt. %, preferably 0.1 to 4.0 wt. %, more preferably 0.2 to 3.0 wt. %, and even more preferably 0.2 to 2.0 wt. %, of one or more additives,
wherein all weight amounts are based on the total weight of the polypropylene composition.

According to one preferred embodiment, the polypropylene composition comprises:
(a) 40.0 to 80.0 wt. %, preferably 50.0 to 70.0 wt. %, more preferably 55.0 to 65.0 wt. %, and even more preferably 57.5 to 62.5 wt. %, of the long chain branched polypropylene,
(b) 20.0 to 60.0 wt. %, preferably 30.0 to 50.0 wt. %, more preferably 35.0 to 45.0 wt. %, and even more preferably 37.5 to 42.5 wt. %, of the linear polypropylene, and
(c) 0.01 to 5.0 wt. %, preferably 0.1 to 4.0 wt. %, more preferably 0.2 to 3.0 wt. %, and even more preferably 0.2 to 2.0 wt. %, of one or more additives,
wherein all weight amounts are based on the total weight of the polypropylene composition, and wherein the components (a) to (c) add up to 100 wt. %.

According to one preferred embodiment, the polypropylene composition comprises:
(a) 40.0 to 79.99 wt. %, preferably 50.0 to 69.9 wt. %, more preferably 55.0 to 64.8 wt. %, and even more preferably 57.5 to 62.48 wt. %, of the long chain branched polypropylene,
(b) 20.0 to 60.0 wt. %, preferably 30.0 to 50.0 wt. %, more preferably 35.0 to 45.0 wt. %, and even more preferably 37.5 to 42.5 wt. %, of the linear polypropylene, and
(c) 0.01 to 5.0 wt. %, preferably 0.1 to 4.0 wt. %, more preferably 0.2 to 3.0 wt. %, and even more preferably 0.2 to 2.0 wt. %, of one or more additives,
wherein all weight amounts are based on the total weight of the polypropylene composition.

According to one preferred embodiment, the polypropylene composition comprises:
(a) 40.0 to 79.99 wt. %, preferably 50.0 to 69.9 wt. %, more preferably 55.0 to 64.8 wt. %, and even more preferably 57.5 to 62.48 wt. %, of the long chain branched polypropylene,
(b) 20.0 to 60.0 wt. %, preferably 30.0 to 50.0 wt. %, more preferably 35.0 to 45.0 wt. %, and even more preferably 37.5 to 42.5 wt. %, of the linear polypropylene, and
(c) 0.01 to 5.0 wt. %, preferably 0.1 to 4.0 wt. %, more preferably 0.2 to 3.0 wt. %, and even more preferably 0.2 to 2.0 wt. %, of one or more additives,
wherein all weight amounts are based on the total weight of the polypropylene composition, and wherein the components (a) to (c) add up to 100 wt. %.

According to one preferred embodiment, the polypropylene composition essentially consists of or consists of:
(a) 40.0 to 79.99 wt. %, preferably 50.0 to 69.9 wt. %, more preferably 55.0 to 64.8 wt. %, and even more preferably 57.5 to 62.48 wt. %, of the long chain branched polypropylene,
(b) 20.0 to 60.0 wt. %, preferably 30.0 to 50.0 wt. %, more preferably 35.0 to 45.0 wt. %, and even more preferably 37.5 to 42.5 wt. %, of the linear polypropylene, and
(c) 0.01 to 5.0 wt. %, preferably 0.1 to 4.0 wt. %, more preferably 0.2 to 3.0 wt. %, and even more preferably 0.2 to 2.0 wt. %, of one or more additives,
wherein all weight amounts are based on the total weight of the polypropylene composition.

According to one preferred embodiment, the polypropylene composition comprises, and preferably essentially consists of or consists of:
(a) 40.0 to 79.99 wt. %, preferably 50.0 to 69.9 wt. %, more preferably 55.0 to 64.8 wt. %, and even more preferably 57.5 to 62.48 wt. %, of the long chain branched polypropylene,
(b) 20.0 to 59.99 wt. %, preferably 30.0 to 49.9 wt. %, more preferably 35.0 to 44.8 wt. %, and even more preferably 37.5 to 42.3 wt. %, of the linear polypropylene, and
(c) 0.01 to 5.0 wt. %, preferably 0.1 to 4.0 wt. %, more preferably 0.2 to 3.0 wt. %, and even more preferably 0.2 to 2.0 wt. %, of one or more additives,
wherein all weight amounts are based on the total weight of the polypropylene composition.

Preferably, the one or more additives comprise a nucleating agent, and more preferably comprise a talc as nucleating agent. The one or more additives can comprise an additional polymeric material, such as an additional polypropylene.

The polypropylene composition is preferably obtainable or obtained using a mixture of specific starting materials. Preferably, the polypropylene composition is preferably obtainable or obtained by melt-blending a dry blend of specific starting materials.

According to one preferred embodiment of the invention, the polypropylene composition is obtainable or obtained using a mixture, preferably a dry blend, comprising a long chain branched polypropylene starting material and a linear polypropylene starting material, and
wherein the linear polypropylene starting material has the following properties:
i) a melt flow rate MFR₂ (ISO 1133, 2.16 kg load, 230° C.) which is higher than the melt flow rate MFR₂ (ISO 1133, 2.16 kg load, 230° C.) of the long chain branched polypropylene starting material, and
ii) a melt strength F₃₀ (ISO 16790:2005) which is lower than the melt strength F₃₀ (ISO 16790:2005) of the long chain branched polypropylene starting material.

The polypropylene composition is preferably obtainable or obtained using a mixture preferably a dry blend, comprising
40.0 to 80.0 wt. %, preferably 50.0 to 70.0 wt. %, more preferably 55.0 to 65.0 wt. %, and even more preferably 57.5 to 62.5 wt. %, of the long chain branched polypropylene starting material,
20.0 to 60.0 wt. %, preferably 30.0 to 50.0 wt. %, more preferably 35.0 to 45.0 wt. %, and even more preferably 37.5 to 42.5 wt. %, of the linear polypropylene starting material,
wherein the weight amounts are based on the total weight of the mixture, preferably the dry blend.

As regards the long chain branched polypropylene starting material and the linear polypropylene starting material being present in the mixture, it is referred to the embodiments and preferred embodiments of the long chain branched polypropylene starting material and the linear polypropylene starting material described herein above under “Long chain branched polypropylene (a)” and “Linear polypropylene (b)”, respectively.

According to one preferred embodiment, the mixture, preferably dry blend, comprises:
40.0 to 80.0 wt. %, preferably 50.0 to 70.0 wt. %, more preferably 55.0 to 65.0 wt. %, and even more preferably 57.5 to 62.5 wt. %, of the long chain branched polypropylene starting material,
20.0 to 60.0 wt. %, preferably 30.0 to 50.0 wt. %, more preferably 35.0 to 45.0 wt. %, and even more preferably 37.5 to 42.5 wt. %, of the linear polypropylene starting material, and
0.01 to 5.0 wt. %, preferably 0.1 to 4.0 wt. %, more preferably 0.2 to 3.0 wt. %, and even more preferably 0.2 to 2.0 wt. %, of one or more additives,
wherein the weight amounts are based on the total weight of the mixture, preferably the dry blend.

As regards one or more additives being present in the mixture, it is referred to the embodiments and preferred embodiments of the one or more additives described herein above under “Additives (c)”.

According to one preferred embodiment, the mixture, preferably dry blend, comprises:
40.0 to 80.0 wt. %, preferably 50.0 to 70.0 wt. %, more preferably 55.0 to 65.0 wt. %, and even more preferably 57.5 to 62.5 wt. %, of the long chain branched polypropylene starting material,
20.0 to 60.0 wt. %, preferably 30.0 to 50.0 wt. %, more preferably 35.0 to 45.0 wt. %, and even more preferably 37.5 to 42.5 wt. %, of the linear polypropylene starting material, and
0.01 to 5.0 wt. %, preferably 0.1 to 4.0 wt. %, more preferably 0.2 to 3.0 wt. %, and even more preferably 0.2 to 2.0 wt. %, of one or more additives,
wherein the weight amounts are based on the total weight of the mixture, preferably the dry blend, and wherein the components add up to 100 wt. %.

According to one preferred embodiment, the mixture, preferably dry blend, comprises:
40.0 to 79.99 wt. %, preferably 50.0 to 69.9 wt. %, more preferably 55.0 to 64.8 wt. %, and even more preferably 57.5 to 62.48 wt. %, of the long chain branched polypropylene starting material,
20.0 to 60.0 wt. %, preferably 30.0 to 50.0 wt. %, more preferably 35.0 to 45.0 wt. %, and even more preferably 37.5 to 42.5 wt. %, of the linear polypropylene starting material, and
0.01 to 5.0 wt. %, preferably 0.1 to 4.0 wt. %, more preferably 0.2 to 3.0 wt. %, and even more preferably 0.2 to 2.0 wt. %, of one or more additives,
wherein the weight amounts are based on the total weight of the mixture, preferably the dry blend.

According to one preferred embodiment, the mixture, preferably dry blend, comprises:
40.0 to 79.99 wt. %, preferably 50.0 to 69.9 wt. %, more preferably 55.0 to 64.8 wt. %, and even more preferably 57.5 to 62.48 wt. %, of the long chain branched polypropylene starting material,
20.0 to 60.0 wt. %, preferably 30.0 to 50.0 wt. %, more preferably 35.0 to 45.0 wt. %, and even more preferably 37.5 to 42.5 wt. %, of the linear polypropylene starting material, and
0.01 to 5.0 wt. %, preferably 0.1 to 4.0 wt. %, more preferably 0.2 to 3.0 wt. %, and even more preferably 0.2 to 2.0 wt. %, of one or more additives,
wherein the weight amounts are based on the total weight of the mixture, preferably the dry blend, and wherein the components add up to 100 wt. %.

According to one preferred embodiment, the mixture, preferably dry blend, essentially consists of or consists of:
40.0 to 79.99 wt. %, preferably 50.0 to 69.9 wt. %, more preferably 55.0 to 64.8 wt. %, and even more preferably 57.5 to 62.48 wt. %, of the long chain branched polypropylene,
20.0 to 60.0 wt. %, preferably 30.0 to 50.0 wt. %, more preferably 35.0 to 45.0 wt. %, and even more preferably 37.5 to 42.5 wt. %, of the linear polypropylene, and
0.01 to 5.0 wt. %, preferably 0.1 to 4.0 wt. %, more preferably 0.2 to 3.0 wt. %, and even more preferably 0.2 to 2.0 wt. %, of one or more additives,
wherein all weight amounts are based on the total weight of the polypropylene composition.

The one or more additives are preferably present in the mixture, preferably dry blend, in form of a masterbatch. The additive masterbatch preferably comprises a polymeric carrier resin, more preferably a polypropylene, and a nucleating agent, more preferably a talc.

Thus, according to one preferred embodiment, the mixture, preferably dry blend, comprises:
40.0 to 79.99 wt. %, preferably 50.0 to 69.9 wt. %, more preferably 55.0 to 64.8 wt. %, and even more preferably 57.5 to 62.48 wt. %, of the long chain branched polypropylene starting material,
20.0 to 60.0 wt. %, preferably 30.0 to 50.0 wt. %, more preferably 35.0 to 45.0 wt. %, and even more preferably 37.5 to 42.5 wt. %, of the linear polypropylene starting material, and
0.01 to 5.0 wt. %, preferably 0.1 to 4.0 wt. %, more preferably 0.2 to 3.0 wt. %, and even more preferably 0.2 to 2.0 wt. %, of additives which are present in form of a masterbatch, wherein the additives comprise a nucleating agent (e.g. talc) and a polymeric carried resin (e.g. a polypropylene),
wherein the weight amounts are based on the total weight of the mixture, preferably the dry blend, and wherein the components add up to 100 wt. %.

### Foam

One aspect of the invention provides a foam. The foam comprises the polypropylene composition according to one embodiment of the invention.

Preferably, the foam comprises at least 95.0 wt. %, and more preferably in the range of 98.0 to 100 wt. %, of the polypropylene composition, based on the total weight of the foam. The foam preferably essentially consists of, or consists of, the polypropylene composition according to one embodiment of the invention.

The polypropylene composition may be further defined by one or more embodiments of the polypropylene composition as described herein above in the section “Polypropylene composition for preparing a foam”, including the section “The polypropylene composition” and in the appended claims. The components of the polypropylene composition, such as the long chain branched polypropylene (a), the linear polypropylene (b) and the additives (c) may also be further defined by one or embodiments as described herein above in the section “Long chain branched polypropylene (a)”, “Linear polypropylene (b)”, and “Additives (c)”.

The foam preferably has a low density. According to one preferred embodiment, the foam has a density of 100 kg/m³ or less, and more preferably in the range of 20 to 100 kg/m³, and optionally in the range of 20 to 80 kg/m³, like in the range of 40 to 80 kg/m³.

The foam is preferably a foamed sheet. The foamed sheet can have a thickness 10.0 mm or less, and preferably in the range of 0.5 to 10.0 mm, like in the range of 0.5 to 7.0 mm.

According to one preferred embodiment, the foam is a foamed sheet having a thickness of 10.0 mm or less, and preferably in the range of 0.5 to 10.0 mm, and a density of a density of 100 kg/m³ or less, more preferably in the range of 20 to 100 kg/m³, and optionally in the range of 20 to 80 kg/m³, like in the range of 40 to 80 kg/m³.

The foam can have specific properties such as melt strength and shear thinning index.

Preferably, the foam has a melt strength F₃₀ (ISO 16790:2005) of at most 23.0 cN, and more preferably in the range of 5.0 to 23.0 cN, like in the range of 5.0 to 20.0.

It is preferred that the foam has a shear thinning index SHI_{(0.05/300)}, determined as described in the specification, of less than 40.0, preferably in the range of 10.0 to less than 40.0.

According to one preferred embodiment of the invention, the foam has both of the following properties:
i) a melt strength F₃₀ (ISO 16790:2005) of at most 23.0 cN, and preferably in the range of 5.0 to 23.0 cN. like in the range of 5.0 to 20.0, and
ii) a shear thinning index SHI_{(0.05/300)}, determined as described in the specification, of less than 40.0, preferably in the range of 10.0 to less than 40.0.

### Process for Preparing the Polypropylene Composition or a Foam Comprising the Same

In another aspect, the invention provides a process for preparing a polypropylene composition according to one embodiment of the invention or a foam according to one embodiment of the invention.

The process is preferably a melt extrusion process and/or an extrusion foaming process. Such processes are known in the art.

The process is preferably an extrusion foaming process using a tandem foam extrusion line. Said equipment is known in the art. A tandem extrusion line typically comprises a co-rotating twin-screw extruder, for compounding and incorporating the blowing agent, and a single-screw extruder for cooling the expandable melt.

The process comprises the steps of:
a) providing a mixture comprising:
   a long chain branched polypropylene starting material,
   a linear polypropylene starting material, and
   optionally one or more additives;
b) melt blending the mixture provided in step a) to obtain a polypropylene composition as described herein; and
c) optionally foaming the polypropylene composition provided in step b) to obtain a foam as described herein.

The mixture provided in step a) may be present in any form which is suitable for being melt-blended in an extruder. The mixture provided in step a) is preferably a dry blend. The dry blend can be prepared by any means known in the art.

As regards the long chain branched polypropylene starting material and the linear polypropylene starting material being present in the mixture provided in step a), it is referred to the embodiments and preferred embodiments of the long chain branched polypropylene starting material and the linear polypropylene starting material described herein above under “Long chain branched polypropylene (a)” and “Linear polypropylene (b)”, respectively.

The one or more additives may be present as single component(s) or in form of an additive masterbatch. Additive masterbatches are known in the art.

The one or more additives are preferably present in form of an additive masterbatch. The additive masterbatch can comprise a polymeric carrier resin and a nucleating agent. The polymeric carrier resin is preferably a polypropylene, which optionally has a melt flow rate MFR₂ (ISO 1133, 2.16 kg load, 230° C.) in the range of 0.5 to 10.0 g/min, like in the range of 1.0 to 6.0 g/10 min. The nucleating agent is preferably a talc.

The mixture provided in step a), preferably the dry blend, typically comprises the materials in specific weight amounts.

The mixture, preferably dry blend, can comprise
40.0 to 80.0 wt. %, preferably 50.0 to 70.0 wt. %, more preferably 55.0 to 65.0 wt. %, and even more preferably 57.5 to 62.5 wt. %, of the long chain branched polypropylene starting material,
20.0 to 60.0 wt. %, preferably 30.0 to 50.0 wt. %, more preferably 35.0 to 45.0 wt. %, and even more preferably 37.5 to 42.5 wt. %, of the linear polypropylene starting material,
wherein the weight amounts are based on the total weight of the mixture, preferably the dry blend.

The polypropylene composition preferably comprises one or more additives.

According to one preferred embodiment, the mixture, preferably dry blend, comprises:
40.0 to 80.0 wt. %, preferably 50.0 to 70.0 wt. %, more preferably 55.0 to 65.0 wt. %, and even more preferably 57.5 to 62.5 wt. %, of the long chain branched polypropylene starting material,
20.0 to 60.0 wt. %, preferably 30.0 to 50.0 wt. %, more preferably 35.0 to 45.0 wt. %, and even more preferably 37.5 to 42.5 wt. %, of the linear polypropylene starting material, and
0.01 to 5.0 wt. %, preferably 0.1 to 4.0 wt. %, more preferably 0.2 to 3.0 wt. %, and even more preferably 0.2 to 2.0 wt. %, of one or more additives,
wherein the weight amounts are based on the total weight of the mixture, preferably the dry blend.

According to one preferred embodiment, the mixture, preferably dry blend, comprises:
40.0 to 80.0 wt. %, preferably 50.0 to 70.0 wt. %, more preferably 55.0 to 65.0 wt. %, and even more preferably 57.5 to 62.5 wt. %, of the long chain branched polypropylene starting material,
20.0 to 60.0 wt. %, preferably 30.0 to 50.0 wt. %, more preferably 35.0 to 45.0 wt. %, and even more preferably 37.5 to 42.5 wt. %, of the linear polypropylene starting material, and
0.01 to 5.0 wt. %, preferably 0.1 to 4.0 wt. %, more preferably 0.2 to 3.0 wt. %, and even more preferably 0.2 to 2.0 wt. %, of one or more additives,
wherein the weight amounts are based on the total weight of the mixture, preferably the dry blend, and wherein the components add up to 100 wt. %.

According to one preferred embodiment, the mixture, preferably dry blend, comprises:
40.0 to 79.99 wt. %, preferably 50.0 to 69.9 wt. %, more preferably 55.0 to 64.8 wt. %, and even more preferably 57.5 to 62.48 wt. %, of the long chain branched polypropylene starting material,
20.0 to 60.0 wt. %, preferably 30.0 to 50.0 wt. %, more preferably 35.0 to 45.0 wt. %, and even more preferably 37.5 to 42.5 wt. %, of the linear polypropylene starting material, and
0.01 to 5.0 wt. %, preferably 0.1 to 4.0 wt. %, more preferably 0.2 to 3.0 wt. %, and even more preferably 0.2 to 2.0 wt. %, of one or more additives,
wherein the weight amounts are based on the total weight of the mixture, preferably the dry blend.

According to one preferred embodiment, the mixture, preferably dry blend, comprises:
40.0 to 79.99 wt. %, preferably 50.0 to 69.9 wt. %, more preferably 55.0 to 64.8 wt. %, and even more preferably 57.5 to 62.48 wt. %, of the long chain branched polypropylene starting material,
20.0 to 60.0 wt. %, preferably 30.0 to 50.0 wt. %, more preferably 35.0 to 45.0 wt. %, and even more preferably 37.5 to 42.5 wt. %, of the linear polypropylene starting material, and
0.01 to 5.0 wt. %, preferably 0.1 to 4.0 wt. %, more preferably 0.2 to 3.0 wt. %, and even more preferably 0.2 to 2.0 wt. %, of one or more additives,
wherein the weight amounts are based on the total weight of the mixture, preferably the dry blend, and wherein the components add up to 100 wt. %.

According to one preferred embodiment, the mixture, preferably dry blend, essentially consists of or consists of:
40.0 to 79.99 wt. %, preferably 50.0 to 69.9 wt. %, more preferably 55.0 to 64.8 wt. %, and even more preferably 57.5 to 62.48 wt. %, of the long chain branched polypropylene,
20.0 to 60.0 wt. %, preferably 30.0 to 50.0 wt. %, more preferably 35.0 to 45.0 wt. %, and even more preferably 37.5 to 42.5 wt. %, of the linear polypropylene, and
0.01 to 5.0 wt. %, preferably 0.1 to 4.0 wt. %, more preferably 0.2 to 3.0 wt. %, and even more preferably 0.2 to 2.0 wt. %, of one or more additives,
wherein all weight amounts are based on the total weight of the polypropylene composition.

The one or more additives are preferably present in the mixture in form of a masterbatch. The additive masterbatch preferably comprises a polymeric carrier resin, more preferably a polypropylene, and a nucleating agent, more preferably a talc.

Thus, according to one preferred embodiment, the mixture, preferably dry blend, comprises:
40.0 to 79.99 wt. %, preferably 50.0 to 69.9 wt. %, more preferably 55.0 to 64.8 wt. %, and even more preferably 57.5 to 62.48 wt. %, of the long chain branched polypropylene starting material,
20.0 to 60.0 wt. %, preferably 30.0 to 50.0 wt. %, more preferably 35.0 to 45.0 wt. %, and even more preferably 37.5 to 42.5 wt. %, of the linear polypropylene starting material, and
0.01 to 5.0 wt. %, preferably 0.1 to 4.0 wt. %, more preferably 0.2 to 3.0 wt. %, and even more preferably 0.2 to 2.0 wt. %, of additives which are present in form of a masterbatch, wherein the additives comprise a nucleating agent (e.g. talc) and a polymeric carried resin (e.g. a polypropylene),
wherein the weight amounts are based on the total weight of the mixture, preferably the dry blend, and wherein the components add up to 100 wt. %.

In step b), the mixture provided in step a) is melt-blended to obtain a polypropylene composition as described herein. The melt-blending step can be carried out by any suitable means known in the art, and preferably in an extruder. Suitable extruder can be selected by the person with skill in the art.

In case the optional foaming step c) is not carried out, the polypropylene composition can be obtained, preferably extruded, in form a melt-compounded polypropylene composition.

It is however preferred that the process comprises step c) of foaming the polypropylene composition provided in step b) to obtain a foam as described herein.

Step c) is preferably carried out using a physical blowing agent in an extrusion foaming process. The physical blowing agent is typically a gas such as butane.

### Use

Another aspect of the invention provides a use of a polypropylene composition as described herein for preparing a foam.

Regarding the possible embodiments and preferred embodiments of the polypropylene composition which can used for preparing the foam, and of the foam which can be prepared, it is referred to the embodiments and preferred embodiments as described herein above.

Without limiting the foregoing disclosure in any way, further aspects and embodiments of the present invention are defined in the following non-limiting items [1] to [15]:

[1]A polypropylene composition for preparing a foam, the polypropylene composition comprises:
(a) at least 40.0 wt. % of a long chain branched polypropylene, and
(b) at least 20.0 wt. % of a linear polypropylene,
wherein the weight amounts are based on the total weight of the polypropylene composition, and
wherein the polypropylene composition has a melt flow rate MFR₂ (ISO 1133, 2.16 kg load, 230° C.) of at least 2.5 g/10 min.

[2] The polypropylene composition according to item [1], wherein the polypropylene composition comprises:
(a) 40.0 to 80.0 wt. %, preferably 50.0 to 70.0 wt. %, more preferably 55.0 to 65.0 wt. %, and even more preferably 57.5 to 62.5 wt. %, of the long chain branched polypropylene,
(b) 20.0 to 60.0 wt. %, preferably 30.0 to 50.0 wt. %, more preferably 35.0 to 45.0 wt. %, and even more preferably 37.5 to 42.5 wt. %, of the linear polypropylene, and
(c) optionally 0.01 to 5.0 wt. %, preferably 0.1 to 4.0 wt. %, more preferably 0.2 to 3.0 wt. %, and even more preferably 0.2 to 2.0 wt. %, of one or more additives,
wherein all weight amounts are based on the total weight of the polypropylene composition, and optionally wherein the components (a) to (c) add up to 100 wt. %.

[3] The polypropylene composition according to item [1] or [2], wherein the polypropylene composition has one or more of, preferably two or more of, and more preferably all of, the following properties:
i) a melt strength F₃₀ (ISO 16790:2005) of at least 5.0 cN, preferably in the range of 5.0 to 30.0 cN, more preferably in the range of 5.0 to 27.5 cN, and even more preferably in the range of 5.0 to 23.0 cN;
ii) a melt flow rate MFR₂ (ISO 1133, 2.16 kg load, 230° C.) in the range of 2.5 to 30.0 g/10 min, and preferably in the range of 3.0 to 20.0 g/10 min; and
iii) a melt extensibility v₃₀ (ISO 16790:2005) in the range of 180 to 320 mm/s, preferably 200 to 280 mm/s, and more preferably 220 to 260 mm/s.

[4] The polypropylene composition according to any one of item [1] to [3], wherein the polypropylene composition has a shear thinning index SHI_{(0.05/300)}, determined as described in the specification, of less than 40.0, and preferably in the range of 10.0 to less than 40.0.

[5] The polypropylene composition according to any one of items [1] to [4], wherein the long chain branched polypropylene is a long chain branched propylene homopolymer.

[6] The polypropylene composition according to any one of items [1] to [5], wherein the linear polypropylene is a linear propylene homopolymer.

[7] The polypropylene composition according to any one of items [1] to [6], wherein the polypropylene composition comprises one or more additives, wherein the one or more additives comprise a nucleating agent, preferably a talc as nucleating agent.

[8] The polypropylene composition according to any one of items [1] to [7], wherein the long chain branched polypropylene is derived from a long chain branched polypropylene starting material having one or more of, preferably two or more of, and more preferably all of, the following properties:
i) a melt strength F₃₀ (ISO 16790:2005) of 20.0 to 50.0 cN, preferably in the range of 25.0 to 45.0 cN, and more preferably in the range of 30.0 to 40.0 cN,
ii) a melt extensibility v₃₀ (ISO 16790:2005) in the range of 190 to 320 mm/s, preferably 210 to 300 mm/s, and more preferably 230 to 280 mm/s,
iii) a melt flow rate MFR₂ (ISO 1133, 2.16 kg load, 230° C.) in the range of 0.5 to 5.0 g/10 min, preferably 1.0 to 3.0 g/10 min, and more preferably 1.2 to 2.5 g/10 min.

[9] The polypropylene composition according to any one of items [1] to [8], wherein the linear polypropylene is derived from a linear polypropylene starting material having one or more of, preferably two or more of, and more preferably all of, the following properties:
i) a melt strength F₃₀ (ISO 16790:2005) of at most 15.0 cN, preferably at most 10.0 cN, and more preferably at most 8.0 cN;
ii) a melt extensibility v₃₀ (ISO 16790:2005) of at most 210 mm/s, preferably at most 200 mm/s, and more preferably of at most 190 mm/s,
iii) a melt flow rate MFR₂ (ISO 1133, 2.16 kg load, 230° C.) in the range of 2.0 to 50.0 g/10 min, preferably 2.5 to 40.0 g/10 min, and more preferably 2.8 to 30.0 g/10 min.

[10] The polypropylene composition according to any one of items [1] to [9], wherein the polypropylene composition is obtainable or obtained using a mixture, and preferably a dry blend, comprising a long chain branched polypropylene starting material and a linear polypropylene starting material,
the linear polypropylene starting material having the following properties:
i) a melt flow rate MFR₂ (ISO 1133, 2.16 kg load, 230° C.) which is higher than the melt flow rate MFR₂ (ISO 1133, 2.16 kg load, 230° C.) of the long chain branched polypropylene starting material, and
ii) a melt strength F₃₀ (ISO 16790:2005) which is lower than the melt strength F₃₀ (ISO 16790:2005) of the long chain branched polypropylene starting material.

[11]A foam comprising the polypropylene composition according to any one of items [1] to [10].

[12] The foam according to item [11], wherein the foam has a density of 100 kg/m³ or less, preferably in the range of 20 to 100 kg/m³, measured according to ISO 845.

[13] The foam according to item [11] or [12], wherein the foam has one or both of the following properties:
i) a melt strength F₃₀ (ISO 16790:2005) of at most 23.0 cN, and preferably in the range of 5.0 to 23.0 cN,
ii) a shear thinning index SHI_{(0.05/300)}, determined as described in the specification, of less than 40.0, and preferably in the range of 10.0 to less than 40.0.

[14]A process for preparing a polypropylene composition according to any one of items [1] to [10] or a foam according to any one of items [11] to [13],
wherein the process comprises the steps of:
a) providing a mixture comprising:
   a long chain branched polypropylene starting material,
   a linear polypropylene starting material, and
   optionally one or more additives;
b) melt blending the mixture provided in step a) to obtain a polypropylene composition; and
c) optionally foaming the melt-blended mixture provided in step b) to obtain a foam.

[15] Use of a polypropylene composition according to any one of items [1] to [10] for preparing a foam.

In the following, the invention is described by specific examples which shall not be construed in limiting the invention in any way.

### Examples Section

### Methods

### Melt Flow Rate (MFR):

The melt flow rates MFR have been determined according to ISO 1133 under a load of 2.16 kg and at a temperature of 230° C.

Melt Strength F₃₀ and Melt Extensibility v₃₀:

The test described herein follows ISO 16790:2005. The tests were carried out at a pressure of 30 bar.

The strain hardening behaviour is determined by the method as described in the article “Rheotens-Mastercurves and Drawability of Polymer Melts”, M. H. Wagner, Polymer Engineering and Sience, Vol. 36, pages 925 to 935. The content of the document is included by reference. The strain hardening behaviour of polymers is analysed by Rheotens apparatus (product of Göttfert, Siemensstr.2, 74711 Buchen, Germany) in which a melt strand is elongated by drawing down with a defined acceleration.

The Rheotens experiment simulates industrial spinning and extrusion processes. In principle a melt is pressed or extruded through a round die and the resulting strand is hauled off. The stress on the extrudate is recorded, as a function of melt properties and measuring parameters (especially the ratio between output and haul-off speed, practically a measure for the extension rate). For the results presented below, the materials were extruded with a lab extruder HAAKE Polylab system and a gear pump with cylindrical die (L/D=6.0/2.0 mm). The gear pump was pre-adjusted to a strand extrusion rate of 5 mm/s, and the melt temperature was set to 200° C. The spinline length between die and Rheotens wheels was 80 mm. At the beginning of the experiment, the take-up speed of the Rheotens wheels was adjusted to the velocity of the extruded polymer strand (tensile force zero): Then the experiment was started by slowly increasing the take-up speed of the Rheotens wheels until the polymer filament breaks. The acceleration of the wheels was small enough so that the tensile force was measured under quasi-steady conditions. The acceleration of the melt strand drawn down is 120 mm/sec². The Rheotens was operated in combination with the PC program EXTENS. This is a real-time data-acquisition program, which displays and stores the measured data of tensile force and drawdown speed. The end points of the Rheotens curve (force versus pulley rotary speed) is taken as the F₃₀ melt strength and drawability values.

### Shear Thinning Index SHI_{(0.05/300)}:

The characterization of polymer melts by dynamic shear measurements complies with ISO standards 6721-1 and 6721-10. The measurements were performed on an Anton Paar MCR501 stress controlled rotational rheometer, equipped with a 25 mm parallel plate geometry. Measurements were undertaken on compression molded plates using nitrogen atmosphere and setting a strain within the linear viscoelastic regime. The oscillatory shear tests were done at 200° C. applying a frequency range between 0.01 and 600 rad/s and setting a gap of 1.3 mm.

In a dynamic shear experiment the probe is subjected to a homogeneous deformation at a sinusoidal varying shear strain or shear stress (strain and stress controlled mode, respectively). On a controlled strain experiment, the probe is subjected to a sinusoidal strain that can be expressed by

$$γ ( t ) = {γ}_{0} sin ( ω t ) \qquad ( 1 )$$

If the applied strain is within the linear viscoelastic regime, the resulting sinusoidal stress response can be given by

$$σ ( t ) = {σ}_{0} sin ( ω t + δ ) \qquad ( 2 )$$

where σ₀, and γ₀ are the stress and strain amplitudes, respectively; ω is the angular frequency; δ is the phase shift (loss angle between applied strain and stress response); t is the time.

Dynamic test results are typically expressed by means of several different rheological functions, namely the shear storage modulus, G′, the shear loss modulus, G″, the complex shear modulus, G*, the complex shear viscosity, η*, the dynamic shear viscosity, η′, the out-of-phase component of the complex shear viscosity, η″ and the loss tangent, tan η, which can be expressed as follows:

$${G}^{′} = \frac{{σ}_{0}}{{γ}_{0}} cos δ [ Pa ] \qquad ( 3 )$$

$${G}^{″} = \frac{{σ}_{0}}{{γ}_{0}} sin δ [ Pa ] \qquad ( 4 )$$

$${G}^{*} = {G}^{′} + {iG}^{″} [ Pa ] \qquad ( 5 )$$

$${η}^{*} = {η}^{′} - i {η}^{″} [ Pa \cdot s ] \qquad ( 6 )$$

$${η}^{′} = \frac{{G}^{″}}{ω} [ Pa \cdot s ] \qquad ( 7 )$$

$${η}^{″} = \frac{{G}^{′} ,}{ω} [ Pa \cdot s ] \qquad ( 8 )$$

The determination of so-called Shear Thinning Index, which correlates with MWD and is independent of Mw, is done as described in equation 9.

$${SHI}_{( x / y )} = \frac{{Eta}^{*} for ( {G}^{*} = x kPa )}{{Eta}^{*} for ( {G}^{*} = y kPa )} \qquad ( 9 )$$

For example, the SHI_{(0.05/300)} is defined by the value of the complex viscosity, in Pa s, determined for a value of G* equal to 0.05 kPa, divided by the value of the complex viscosity, in Pa s, determined for a value of G* equal to 300 kPa.

The values of storage modulus (G′), loss modulus (G″), complex modulus (G*) and complex viscosity (η*) were obtained as a function of frequency (ω).

Thereby, e.g. η*_{300rad/s} (eta*_{300rad/s}) is used as abbreviation for the complex viscosity at the frequency of 300 rad/s and η*_{0.05rad/s} (eta*_{0.05rad/s}) is used as abbreviation for the complex viscosity at the frequency of 0.05 rad/s.

The loss tangent tan (delta) is defined as the ratio of the loss modulus (G″) and the storage modulus (G) at a given frequency. Thereby, e.g. tan_{0.05} is used as abbreviation for the ratio of the loss modulus (G″) and the storage modulus (G) at 0.05 rad/s and tan₃₀₀ is used as abbreviation for the ratio of the loss modulus (G″) and the storage modulus (G) at 300 rad/s.

The elasticity balance tan_{0.05}/tan₃₀₀ is defined as the ratio of the loss tangent tan_{0.05} and the loss tangent tan₃₀₀.

Besides the above mentioned rheological functions one can also determine other rheological parameters such as the so-called elasticity index EI(x). The elasticity index EI(x) is the value of the storage modulus (G) determined for a value of the loss modulus (G″) of x kPa and can be described by equation 10.

$$EI ( x ) = {G}^{′} for ( {G}^{′} = x kPa ) [ Pa ] \qquad ( 10 )$$

For example, the EI(5 kPa) is the defined by the value of the storage modulus (G′), determined for a value of G″ equal to 5 kPa.

The viscosity eta₇₄₇ is measured at a very low, constant shear stress of 747 Pa and is inversely proportional to the gravity flow of the polyethylene composition, i.e. the higher eta₇₄₇ the lower the sagging of the polyethylene composition.

The polydispersity index, PI, is defined by equation 11.

$$PI = \frac{1 {0}^{5}}{{G}^{′} ( {ω}_{COP} )} , {ω}_{COP} = ω for ( {G}^{′} = {G}^{″} ) \qquad ( 11 )$$

where ω_{COP} is the cross-over angular frequency, determined as the angular frequency for which the storage modulus, G′, equals the loss modulus, G″.

The values are determined by means of a single point interpolation procedure, as defined by Rheoplus software. In situations for which a given G* value is not experimentally reached, the value is determined by means of an extrapolation, using the same procedure as before. In both cases (interpolation or extrapolation), the option from Rheoplus “Interpolate y-values to x-values from parameter” and the “logarithmic interpolation type” were applied.

### REFERENCES

[1]“Rheological characterization of polyethylene fractions”, Heino, E. L., Lehtinen, A., Tanner J., Seppala, J., Neste Oy, Porvoo, Finland, Theor. Appl. Rheol., Proc. Int. Congr. Rheol, 11th (1992), 1, 360-362.
[2]“The influence of molecular structure on some rheological properties of polyethylene”, Heino, E. L., Borealis Polymers Oy, Porvoo, Finland, Annual Transactions of the Nordic Rheology Society, 1995.
[3]“Definition of terms relating to the non-ultimate mechanical properties of polymers”, Pure & Appl. Chem., Vol. 70, No. 3, pp. 701-754, 1998.

### Foam Density:

Foam density was measured according to ISO 845 using an analytical and semi-micro precision balance of Switzerland PRECISA Gravimetrics AG, Switzerland.

### Starting Materials

Long Chain Branched Polypropylene Starting Material (b-PP):

The long chain branched polypropylene starting material (b-PP) was the product Daploy WB140HMS commercially available from Borealis AG. The properties of the material before compounding and after compounding are indicated in Table 1.

### Linear Polypropylene Starting Materials (I-PP):

Four different linear polypropylenes (I-PP) were used as starting materials.
L-PP-1: propylene homopolymer available as BE50 from Borealis AG
L-PP-2: propylene homopolymer available as HC600TF from Borealis AG
L-PP-3: propylene homopolymer available as HE125MO from Borealis AG
L-PP-4: propylene homopolymer available as HG313MO from Borealis AG.

The properties of the materials before compounding and after compounding are indicated in Table 1.

### Additive Masterbatch (AM):

A commercially available additive masterbatch (AM) was used. The additive masterbatch contains about 70 wt. % of a nucleating agent, which is a talc, and about 30 wt. % of a polypropylene. The polypropylene having a melt index (230° C./2.16 kg) of about 4 g/10 min.

### Examples

### 1) Melt-Compounded Polypropylene Compositions

Melt-compounded blends comprising 60 wt. % of long chain branched polypropylene b-PP and 40 wt. % of linear polypropylene I-PP were prepared using a ZSK 32MC twin-screw extruder. The individual components were also exposed to the same compounding step as the tested blends by using the same conditions as in the blend preparation in order to see the effect of processing step on the properties of each components individually.

The properties of the individual components before and after compounding are shown in Table 1 and the properties of the melt-compounded blends are shown in Table 2.

TABLE 1
Properties of individual components before compounding (b.c.) and after compounding (a.c.).

| | | b-PP | | I-PP-1 | | I-PP-2 | | I-PP-3 | | I-PP-4 | |
|---|---|---|---|---|---|---|---|---|---|---|---|
| | | b.c. | a.c | b.c. | a.c | b.c. | a.c | b.c. | a.c | b.c. | a.c |
| MFR2 | g/10 min | 1.77 | 8.75 | 0.26 | 0.37 | 3.06 | 3.78 | 13.31 | 14.72 | 28.07 | 31.34 |
| F30 | cN | 34.1 | 6.3 | 54.8 | 30.5 | 6.7 | 5.2 | 1.7 | 0.9 | n.m | n.m |
| v30 | mm/s | 261 | 283 | 155 | 168 | 170 | 171 | 180 | 181 | n.m | n.m |
| eta (0.05 rad/s) | Pa*s | 12510 | 6835 | 78873 | 54748 | 9789 | 7353 | 2530 | 2126 | 865 | 2126 |
| eta (300 rad/s) | Pa*s | 166 | 166 | 679 | 652 | 386 | 373 | 219 | 213 | 192 | 213 |
| PI | Pa\hat{ }-1 | 22.62 | 8.76 | 3.86 | 3.53 | 3.61 | 3.36 | 4 | 3.82 | 2.69 | 3.82 |
| W (c) | rad/s | 3.44 | 27.48 | 1.7 | 2.87 | 21.22 | 29 | 79.85 | 93.52 | 257.37 | 93.52 |

As can be seen from the data shown in Table 1, the compounding of long chain branched polypropylene b-PP has a negative effect on the melt strength which drops from about 34.1 cN to 6.3 cN. The melt flow rate increases significantly. This is a sign of polymer degradation and/or disentanglement of the polymer chains due to the applied shear during the compounding step. A similar effect, but less pronounced, can be seen for the linear polypropylene I-PP-1 which has a very low melt flow rate. In the case of higher MFR linear polypropylene I-PP-2 to I-PP-3 the effect of compounding step on the melt flow rate and melt strength is only minor.

The following melt-compounded blends were prepared from the individual components:
Comparative example CE1: 100 wt. % b-PP
Comparative example CE2: 60 wt. % b-PP+40 wt. % I-PP-1
Inventive example IE1: 60 wt. % b-PP+40 wt. % I-PP-2
Inventive example IE2: 60 wt. % b-PP+40 wt. % I-PP-3
Inventive example IE3: 60 wt. % b-PP+40 wt. % I-PP-4

TABLE 2
Properties of the prepared melt-compounded blends.

| | | CE1 | CE2 | IE1 | IE2 | IE3 |
|---|---|---|---|---|---|---|
| MFR2 | g/10 min | 8.75 | 0.85 | 4.18 | 9.3 | 14.2 |
| F30 | cN | 6.3 | 33.2 | 14 | 7.9 | 6.1 |
| v30 | mm/s | 283 | 233 | 240 | 245 | 247 |
| eta (0.05 | Pa*s | 6835 | 30570 | 8812 | 4744 | 2785 |
| rad/s) | | | | | | |
| eta (300 | Pa*s | 166 | 314 | 241 | 183 | 174 |
| rad/s) | | | | | | |
| PI | Pa\hat{ }-1 | 8.76 | 10.65 | 6.58 | 5.96 | 4.35 |
| W (c) | rad/s | 27.48 | 1.79 | 18.65 | 49.35 | 114.22 |
| SHI (eta | | 41 | 97 | 37 | 26 | 16 |
| 0.05/300) | | | | | | |

The example IE1 to IE3 show a higher melt strength than what would have been expected based on the melt strength measured for the individual components after compounding. The higher melt strength is achieved in combination with a high melt flow rate. Examples IE1 to IE 3 show a lower shear thinning index than examples CE1 and CE2. Example CE2 shows a high melt strength, however the melt flow rate is low with 0.85 g/10 min. The low melt flow rate has a negative effect on the processability of the blend.

### 2) Polypropylene Foams

The following dry blends were prepared:
Comparative example CE3: 99.2 wt. % b-PP+0.8 wt. % AM
Inventive example IE4: 59.2 wt. % b-PP+40.0 wt. % I-PP-3+0.8 wt. % AM
Inventive example IE5: 59.0 wt. % b-PP+40.0 wt. % I-PP-3+1.0 wt. % AM

The dry blends were used to prepare low density polypropylene foams using a KraussMaffei Berstorff tandem foaming line (ZE40 twin screw extruded; KE90 single screw extruder) and iso-butane as foaming agent.

The foaming agent was used in an amount in the range of 3.5 to 7.0 wt. %. The twin screw extruded was operated at a temperature in the range of 20 to 220° C. with a screw speed in the range of 100 to 200 r/min and a specific output in the range of 0.2 to 0.7 kg/h/r/min. The single screw extruded was operated at a temperature in the range of 20 to 190° C. with a screw speed in the range of 2 to 15 r/min and a specific output in the range of 5 to 20 kg/h/r/min.

The foam properties are summarized in Table 3 below.

TABLE 3
Foaming of example CE3 and IE4 and IE5

| | | CE3 | IE4 | IE5 |
|---|---|---|---|---|
| b-PP | wt. % | 99.2 | 59.2 | 59 |
| I-PP-3 | wt. % | — | 40 | 40 |
| AM | wt. % | 0.8 | 0.8 | 1 |
| Melt pressure | | | | |
| Melt pressure in the end of | bar | 92 | 85 | 84 |
| melting extruder ZE40 | | | | |
| Melt pressure in the die | bar | 29 | 28 | 24 |
| Foam properties | | | | |
| Thickness | mm | 2.8 | 2.5 | 2.9 |
| Density | kg/m3 | 53 | 65 | 62 |
| SHI(eta0.05/eta300) | | 49 | 29 | 31 |

As shown in Table 3, the dry blend of example IE4 can be foamed to a low density polypropylene foam using the commercial extrusion foaming process. Furthermore, it was observed that, using the same process settings, the blend comprising linear polypropylene I-PP-3 shows lower pressure levels in the end of extruder ZE40 and in the die which confirms the better processability due to the higher melt flow rate of the blend in comparison with that of CE3.

1. A polypropylene composition for preparing a foam, wherein the polypropylene composition comprises:
(a) at least 40.0 wt. % of a long chain branched polypropylene, and
(b) at least 30.0 wt. % of a linear polypropylene,
wherein the weight amounts are based on the total weight of the polypropylene composition, and
wherein the polypropylene composition has a melt flow rate MFR₂ (ISO 1133, 2.16 kg load, 230° C.) in a range of 2.5 to 30.0 g/10 min.

2. The polypropylene composition according to claim 1, wherein the polypropylene composition comprises:
(a) 50.0 to 70.0 wt. % of the long chain branched polypropylene,
(b) 30.0 to 50.0 wt. % of the linear polypropylene, and
(c) optionally 0.1 to 4.0 wt. % of one or more additives,
wherein all weight amounts are based on the total weight of the polypropylene composition, and optionally wherein the components (a) to (c) add up to 100 wt. %.

3. The polypropylene composition according to claim 1, wherein the polypropylene composition has one or more of the following properties:
i) a melt strength F₃₀ (ISO 16790:2005) of at least 5.0 cN;
ii) a melt flow rate MFR₂ (ISO 1133, 2.16 kg load, 230° C.) in the range of 3.0 to 20.0 g/10 min; and
iii) a melt extensibility v₃₀ (ISO 16790:2005) in the range of 180 to 320 mm/s.

4. The polypropylene composition according to claim 1, wherein the polypropylene composition has a shear thinning index SHI_{(0.05/300)}, determined as described in the specification, of less than 40.0.

5. The polypropylene composition according to claim 1, wherein the long chain branched polypropylene is a long chain branched propylene homopolymer.

6. The polypropylene composition according to claim 1, wherein the linear polypropylene is a linear propylene homopolymer.

7. The polypropylene composition according to claim 1, wherein the polypropylene composition comprises the one or more additives, wherein the one or more additives comprise a nucleating agent.

8. The polypropylene composition according to, wherein the long chain branched polypropylene is derived from a long chain branched polypropylene starting material having one or both of the following properties:
i) a melt strength F₃₀ (ISO 16790:2005) of 20.0 to 50.0 cN,
ii) a melt extensibility v₃₀ (ISO 16790:2005) in the range of 190 to 320 mm/s.

9. The polypropylene composition according to claim 1, wherein the long chain branched polypropylene is derived from a long chain branched polypropylene starting material which is obtained by treating a linear polypropylene with a radical forming agent, optionally in the presence of bifunctionally unsaturated monomer(s) and/or multifunctionally unsaturated low molecular weight polymer(s).

10. The polypropylene composition according to claim 1, wherein the linear polypropylene is derived from a linear polypropylene starting material having one or both of the following properties:
i) a melt strength F₃₀ (ISO 16790:2005) of at most 15.0 cN;
ii) a melt extensibility v₃₀ (ISO 16790:2005) of at most 210 mm/s.

11. The polypropylene composition according to claim 1, wherein the polypropylene composition is obtainable or obtained using a mixture comprising a long chain branched polypropylene starting material and a linear polypropylene starting material,
the linear polypropylene starting material having the following properties:
i) a melt flow rate MFR₂ (ISO 1133, 2.16 kg load, 230° C.) which is higher than the melt flow rate MFR₂ (ISO 1133, 2.16 kg load, 230° C.) of the long chain branched polypropylene starting material, and
ii) a melt strength F₃₀ (ISO 16790:2005) which is lower than the melt strength F₃₀ (ISO 16790:2005) of the long chain branched polypropylene starting material.

12. A foam comprising the polypropylene composition according to claim 1.

13. The foam according to claim 12, wherein the foam has a density of 100 kg/m³ or less measured according to ISO 845.

14. The foam according to claim 12, wherein the foam has one or both of the following properties:
i) a melt strength F₃₀ (ISO 16790:2005) of at most 23.0 cN,
ii) a shear thinning index SHI_{(0.05/300)}, determined as described in the specification, of less than 40.0.

15. A process for preparing a polypropylene composition according to claim 1,
wherein the process comprises the steps of:
a) providing a mixture comprising:
a long chain branched polypropylene starting material,
a linear polypropylene starting material, and
optionally one or more additives;
b) melt blending the mixture provided in step a) to obtain a polypropylene composition; and
c) optionally foaming the melt-blended mixture provided in step b) to obtain a foam.

16. A method of preparing a foam, the method using the polypropylene composition according to claim 1 to prepare the foam.

17. The polypropylene composition according to claim 1, wherein the linear polypropylene is derived from a linear polypropylene starting material having a melt flow rate MFR₂ (ISO 1133, 2.16 kg load, 230° C.) in the range of 2.0 to 50.0 g/10 min.

18. The polypropylene composition according to claim 1, wherein the long chain branched polypropylene is derived from a long chain branched polypropylene starting material having a melt flow rate MFR₂ (ISO 1133, 2.16 kg load, 230° C.) in the range of 0.5 to 5.0 g/10 min.

19. The polypropylene composition according to claim 6, comprising:
(a) 50.0 to 70.0 wt. % of the long chain branched polypropylene,
(b) 30.0 to 50.0 wt. % of the linear polypropylene, and
(c) optionally 0.1 to 4.0 wt. % of one or more additives,
wherein all weight amounts are based on the total weight of the polypropylene composition, and optionally wherein the components (a) to (c) add up to 100 wt. %.

20. The polypropylene composition according to claim 19, wherein the linear polypropylene is derived from a linear polypropylene starting material having a melt flow rate MFR₂ (ISO 1133, 2.16 kg load, 230° C.) in the range of 2.0 to 50.0 g/10 min.
